(19) United States
(12) Patent Application Publication
(10) Pub. No.: US 2015/0218495 A1
(43) Pub. Date: Aug. 6, 2015

(54) REMOVAL OF TEA AND COFFEE STAINS BY FATTY ACID SOAPS

(71) Applicant: ECOLAB USA INC, St. Paul, MN (US)

(72) Inventors: Altony Miralles, Woodbury, MN (US); Carter M. Silvernail, Burnsville, MN (US)

(73) Assignee: ECOLAB USA INC, St. Paul, MN (US)

(21) Appl. No.: 14/173,295

(22) Filed: Feb. 5, 2014

(51) Int. Cl. C11D 9/06

(52) U.S. Cl. CPC C11D 9/06

(57) ABSTRACT

Compositions for removal of coffee and tea stains from dishes and other ware are disclosed. Tea, coffee and other stains caused by tannins are particularly difficult to remove and traditional techniques include harsh treatments that use bleach, or other environmentally undesirable chemicals such as phosphates, EDTA, NTA or other aminocarboxylates. Compositions and methods of employing alkaline fatty acid soaps and are disclosed to remove coffee and tea stains from ceramic, porcelain and other hard surfaces without the need for such strong chelants, bleach and/or bleach activators.

### FIELD OF THE INVENTION

This invention relates to the field of dishwashing and stain removal. Compositions of fatty acid soaps and methods employing the same are disclosed to remove coffee and tea stains from ceramic, porcelain and other hard surfaces without the need for strong chelants, acidic washing, bleach and/or bleach activators. Similarly, compositions and methods are disclosed to remove such coffee and tea stains without the need for phosphates, EDTA, NTA and/or other aminocarboxylate chelants, bleaches and/or bleach activators.

### BACKGROUND OF THE INVENTION

Machine dishwashing detergents constitute a generally recognized distinct class of detergent compositions. In general, machine dishwashing detergents are mixtures of ingredients whose purpose, in combination, is to breakdown and remove food soils; to inhibit foaming caused by certain food soils; to promote the wetting of wash articles in order to minimize or eliminate visually observable spotting and filming; to remove stains including those caused by beverages such as coffee and tea or by vegetable soils such as carotenoid soils; to prevent a buildup of soil films on wash ware surfaces; and to reduce or eliminate tarnishing of flatware.

The high tannic acid content in coffee and tea represent a particularly difficult problem for warewash cleaning These drinks often lead to stubborn brown stains on dishes, glasses, coffee mugs and teacups. Traditionally, alkaline products containing chlorine bleach have been used for this purpose. Many such products also use high (20% or more) levels of phosphate builders. Chlorine bleach and alkalis have an aggressive effect on silverware, china and crystal; they have issues of product safety; and compliance with regulatory requirements in different geographies necessitates the same.

Although the cleaning performance of these conventional detergent compositions is satisfactory, high phosphate levels, chlorine bleach, and high alkalinity have potential environmental and consumer drawbacks. As a result, an alternative technology was developed to deliver less alkaline products. Similarly, nonphosphated builders are substituted to further improve the environmental profile of the composition, but with less cleaning ability and this is particularly so for stubborn stains such as those caused by tea and coffee themselves or when mixed with dairy products. As a consequence of the reduced cleaning efficiency of the modified composition, various detersive enzymes including amylolytic and proteolytic enzymes have been employed to boost removal of starchy and proteinaceous soils, respectively. Because these enzymes are not compatible with chlorine bleach systems, an oxygen bleaching system has been substituted which can result in a reduction in bleach performance. Often, enzymatic compositions based on oxygen bleaches are formulated with a phosphate builder, in markets where local legislation will allow, assuring good overall performance. An unfortunate weakness in the performance of this alternative technology, is that both formulations are phosphated (i.e., containing inorganic phosphate builder salts) and therefore environmentally undesirable.

Typical cleaning of tea and coffee stains is obtained by the use of such bleaching components in detergents. Bleaching compositions and bleach systems are well known and in the art. Chlorine and N,N,N′,N′-tetraacetylethylenediamine (TAED)/perborate, for example, are well known for their bleaching properties. Cationic bleach systems that include cationic nitrites in the presence of peroxide are also known (see, for example, U.S. Pat. Nos. 5,236,616 and 5,281,361), the contents of which are incorporated herein by their reference). Other known cationic group containing organic bleach activators or bleach catalysts include, for example, cholyl(4-sulfophenyl)carbonate (CSPC, see, for example, U.S. Pat. No. 5,106,528 and EP 399,584 B1), quaternary imine salts (e.g. N-methyl-3,4-dihydroisoquinolinium p-toluenesulfonate, U.S. Pat. Nos. 5,360,568, 5,360,569 and 5,370,826), each of which are herein incorporated by reference in its entirety. Cationic peroxyacids, such as those described in U.S. Pat. Nos. 5,908,820, 5,422,028, 5,294,362 and 5,292,447, have also shown good bleaching activity over a wide range of pH conditions, each of which are herein incorporated by reference in its entirety. Oxygen bleach, specifically perborate in combination with the bleach activator tetraacetylethylenediamine (TAED), has been introduced commercially as a chlorine bleach replacement in certain automatic dishwashing products. However, testing demonstrates that, with or without the TAED component, this bleach system is very poor in its effectiveness, even when used at much higher levels than a chlorine system, on a mass basis.

A number of systems have been described in the art for promoting more effective bleaching and/or stain removal for stains, including tea and coffee. For example, various efforts have been made to improve the efficacy of bleach activators and hundreds of such activators have been described. Bleach activators may, for example, yield unacceptably depositing, foam-forming or malodorous peracids, none of which are acceptable for automatic dishwashing, especially in a spray-action domestic dishwasher. There has been little teaching in the art as to more effective removal of coffee and tea stains without the need for bleach and/or bleach activators, either as a pretreatment and/or within automatic dishwashing applications.

Accordingly it is an object herein to provide an improved process for the removal of tea coffee and other similar stains (e.g. any polyphenol stain) without the need for bleach, bleach activators, phosphates, and/or chelants such as the aminocarboxylates EDTA and/or NTA.

It is another object of the invention to provide a method and process for removing coffee, tea and other stains caused by tannins from ceramics, porcelain and the like in either a pre-treatment and/or ware washing applications.

It is yet another object to provide cleaning solutions that are safe, environmentally friendly and economically feasible.

Yet another object is to provide cleaning methods for tea and coffee stain removal than are more environmentally-friendly and biodegradable and which includes components which are generally recognized as safe.

Other objects, aspects and advantages of this invention will be apparent to one skilled in the art in view of the following disclosure, the drawings, and the appended claims.

### SUMMARY OF THE INVENTION

Applicants have surprisingly discovered that a pre-soak with fatty acid soap prior to typical alkaline cleaning of dishware can effectively remove up to one hundred percent of tea and coffee stains. Such removal efficacy includes the removal of well-established stains that have been on the article for long periods of time. The invention thus provides compositions and methods for washing and cleaning dishware that contains stains from coffee or tea.

According to the methods of the invention, a first cleaning step includes a pre-soak in an alkaline solution of fatty acid soap. Preferably, the pH is at about 10 to about 10.5 for a sufficient time and at an appropriate temperature to solubilize the stain and remove the stain from the substrate surface. Without being limited according to a mechanism of action of the invention, the time and temperature are not critical for methods according to the invention but are inversely related. Beneficially, the use of temperatures in excess of room temperature will decrease the amount of time required for the pre-soak. In some aspects it is desirable to use a temperature in excess of about 80-90° F., preferably temperatures of at least about 100° F. or greater, or up to about 160° F. (or greater) for the pre-soak to decrease the amount of time required for stain removal according to the embodiments of the invention.

The present method provides a method for stain removal and for washing dishes and other ware comprising: (a) soaking or spraying contacting said ware to be washed with the alkaline fatty acid soap solution according to the compositions of the invention, said solution having an alkaline pH, preferably a pH of at least about 8, or at least about 9 for a time sufficient for stain removal; (b) optionally rinsing with water, if desired and thereafter, (c) applying a traditional alkaline detergent composition to the dishes (e.g. ware wash application within a dishmachine), and (d) rinsing with water; wherein the soaking step is performed at a sufficient time and temperature so that the tea and/or coffee stain removal is initiated and/or completely removed. Without being limited according to a mechanism of action of the present invention, the pre-soak step according to the invention loosens and/or removes the stains by solubilizing the calcium ions within the stain so that they can be removed during such pre-soak and/or upon rinsing. In an aspect, the pre-soak can be followed by the traditional alkaline cleaning step without the need for conventional bleach and/or strong chelants to effectuate such removal. The alkaline presoak according to the invention can be performed either outside of a warewash machine, or within a warewash machine as part of a two or more step process.

In accordance with another of its aspects, the present invention provides an alkaline pre-soak composition for use in the above method. Also provided is a detergent system, comprising a presoak composition having an alkaline pH, and a detergent composition having alkaline pH.

Accordingly, in one embodiment, the invention pertains to a method of cleaning dishes and other ware in a dishwashing protocol using an alkaline pre-soak composition comprising a fatty acid soap, alkalinity source and optional ingredients, including for example surfactants. The invention also pertains in some embodiments to a method of cleaning articles in a dishwashing machine using an alkaline pre-soak composition.

These and other objects, advantages and features of the present invention will become apparent from the following specification taken in conjunction with the claims set forth herein.

### DETAILED DESCRIPTION

The embodiments of this invention are not limited to particular methods and/or compositions for removal of tea and coffee stains without having to use strong chelants and/or bleaches, which can vary and are understood by skilled artisans. It is further to be understood that all terminology used herein is for the purpose of describing particular embodiments only, and is not intended to be limiting in any manner or scope. For example, as used in this specification and the appended claims, the singular forms “a,” “an” and “the” can include plural referents unless the content clearly indicates otherwise. Further, all units, prefixes, and symbols may be denoted in its SI accepted form. Numeric ranges recited within the specification are inclusive of the numbers defining the range and include each integer within the defined range. So that the invention maybe more readily understood, certain terms are first defined and certain test methods are described.

The term “about,” as used herein, modifying the quantity of an ingredient in the compositions of the invention or employed in the methods of the invention refers to variation in the numerical quantity that can occur, for example, through typical measuring and liquid handling procedures used for making concentrates or use solutions; through inadvertent error in these procedures; through differences in the manufacture, source, or purity of the ingredients employed to make the compositions or carry out the methods; and the like. The term about also encompasses amounts that differ due to different equilibrium conditions for a composition resulting from a particular initial mixture. Whether or not modified by the term “about,” the claims include equivalents to the quantities. All numeric values are herein assumed to be modified by the term “about,” whether or not explicitly indicated. The term “about” generally refers to a range of numbers that one of skill in the art would consider equivalent to the recited value (i.e., having the same function or result). In many instances, the terms “about” may include numbers that are rounded to the nearest significant figure.

As used herein, the term “cleaning” refers to a method used to facilitate or aid in soil removal, bleaching, microbial population reduction, and any combination thereof. As used herein, the term “microorganism” refers to any noncellular or unicellular (including colonial) organism. Microorganisms include all prokaryotes. Microorganisms include bacteria (including cyanobacteria), spores, lichens, fungi, protozoa, virinos, viroids, viruses, phages, and some algae. As used herein, the term “microbe” is synonymous with microorganism.

As used herein, the term “phosphate-free” refers to a composition, mixture, or ingredient that does not contain a phosphate or phosphate-containing compound or to which a phosphate or phosphate-containing compound has not been added. Should a phosphate or phosphate-containing compound be present through contamination of a phosphate-free composition, mixture, or ingredients, the amount of phosphate shall be less than 0.5 wt %. More preferably, the amount of phosphate is less than 0.1 wt. %, and most preferably, the amount of phosphate is less than 0.01 wt %.

As used herein, the term “phosphorus-free” refers to a composition, mixture, or ingredient that does not contain phosphorus or a phosphorus-containing compound or to which phosphorus or a phosphorus-containing compound has not been added. Should phosphorus or a phosphorus-containing compound be present through contamination of a phosphorus-free composition, mixture, or ingredients, the amount of phosphorus shall be less than 0.5 wt %. More preferably, the amount of phosphorus is less than 0.1 wt. %, and most preferably the amount of phosphorus is less than 0.01 wt %.

As used herein, the term “ware” refers to items such as eating and cooking utensils, dishes, and other hard surfaces such as showers, sinks, toilets, bathtubs, countertops, windows, mirrors, transportation vehicles, and floors. As used herein, the term “warewashing” refers to washing, cleaning, or rinsing ware. Ware also refers to items made of plastic. Types of plastics that can be cleaned with the compositions according to the invention include but are not limited to, those that include polycarbonate polymers (PC), acrilonitrile-butadiene-styrene polymers (ABS), and polysulfone polymers (PS). Another exemplary plastic that can be cleaned using the compounds and compositions of the invention include polyethylene terephthalate (PET).

As used herein, “weight percent,” “wt-%,” “percent by weight,” “% by weight,” and variations thereof refer to the concentration of a substance as the weight of that substance divided by the total weight of the composition and multiplied by 100. It is understood that, as used here, “percent,” “%,” and the like are intended to be synonymous with “weight percent,” “wt-%,” etc.

The recitation of numerical ranges by endpoints includes all numbers subsumed within that range (e.g. 1 to 5 includes 1, 1.5, 2, 2.75, 3, 3.80, 4, and 5).

Alkaline Cleaning Compositions

According to an embodiment of the invention, cleaning compositions for removal of coffee and tea stains obviate the need for and/or conventional concentrations of strong chelants, such as phosphates, EDTA, MGDA, GLDA, NTA and/or other aminocarboxylate chelants. In addition, the cleaning compositions according to the invention obviate the need for bleaches, such as halogen-based bleaches or oxygen-based bleaches, bleach precursors and/or bleach activators for the removal of coffee and tea stains, such as those disclosed in U.S. Pat. Nos. 3,332,882, 4,128,494, 4,751,015 and 4,818,426. Still further, use of the cleaning compositions according to embodiments of the invention for removal of coffee and tea eliminate the need for use of acidic compositions, including prewash and/or soaks, such as organic acids including hydroxyacetic (glycolic) acid, citric acid, tartaric acid, lactic acid, ascorbic acid, gallic acid, formic acid, acetic acid, propionic acid, butyric acid, valeric acid, caproic acid, gluconic acid, itaconic acid, trichloroacetic acid, dicarboxylic acids, urea sulfate, and benzoic acid, among others, and/or inorganic acids or mineral acids including phosphoric acid, sulfuric acid, sulfamic acid, methylsulfamic acid, hydrochloric acid, hydrobromic acid, hydrofluoric acid, and nitric acid among others. Still further, use of the cleaning compositions according to embodiments of the invention for removal of coffee and tea eliminate the use of silicates for stain removal.

Exemplary ranges of the concentrated fatty acid soap compositions according to the invention are shown in Table 1 in weight percentage of the concentrated, cleaning compositions. The component concentrations of the detergent compositions will vary depending on whether the cleaning composition is in concentrated or ready-to-use dilution.

TABLE 1

| | First | Second | Third | Fourth |
|---|---|---|---|---|
| | Exemplary | Exemplary | Exemplary | Exemplary |
| Material | Range wt-% | Range wt-% | Range wt-% | Range wt-% |
| Fatty acid soap | 0.01-100 | 0.1-90 | 5-80 | 5-50 |
| Alkalinity | 0.01-50 | 0.1-50 | 2-40 | 5-40 |
| source of | | | | |
| the fatty | | | | |
| acid soap | | | | |
| Additional | 0-50 | 0.01-40 | 0.1-40 | 1-25 |
| functional | | | | |
| ingredient(s) | | | | |

The compositions according to the invention are preferably used at use concentrations of at least about 100 ppm, at least about 1,000 ppm, preferably at least 5,000 ppm, and still more preferably at 10,000 ppm or greater. Without being limited according to the invention, lower concentrations of the fatty acid soap composition, such as about 100 ppm, efficaciously remove soils according to the invention. In an aspect, the lower the use of fatty acid soap composition ppm may require additional time for the pre-soak step of the invention. Similarly, when more stubborn or set-in stains are sought to be removed using lower concentrations of the fatty acid soap composition, a skilled artisan will understand that more time for the pre-soak step will be required in comparison to soaks for removing less set-in stains. The fatty acid soap compositions according to the invention have a use solution pH of at least about 10. In other aspects the compositions according to the invention have a use solution pH of at least about 10, to about 11 or greater. Beneficially, the fatty acid soap compositions are phase stable.

Use solutions of the alkaline pre-soak concentrated compositions (such as those disclosed in Table 1) according to the invention may employ substantially only the fatty acid soap and alkalinity source, or in other embodiments additional functional ingredients may be employed. It is to be understood that sufficient fatty acids are provided to the pre-soak composition to destroy hardness and solubilize the stain. In addition, the concentration (ppm) of the alkali metal fatty acids is provided at such a concentration to push the equilibrium on the polyphenol stains to release the calcium ions from the stains solubilizing and removing the stains. In an exemplary embodiment, at least 100 ppm, at least 300 ppm or at least 500 ppm of fatty acid soap is provided in a pre-soak composition to push the equilibrium and solubilize the stains for removal according to the invention.

Fatty Acid Soaps

In some aspects, the compositions include fatty acid soaps/fatty acid compositions.

In some aspects, the compositions include one or more fatty acid. As used herein, the term “fatty acid” includes any of a group of carboxylic acids that include a long alkyl chain. In some embodiments, the alkyl groups can be linear or branched, and saturated or unsaturated. The chain of alkyl groups contain from at least 5 to 24 carbon atoms, 8 to 22 carbon atoms, or 12 to 18 carbon atoms. In some embodiments, the chain of alkyl groups contains a mixture of varying alkyl group chains fatty acids, such as a mixture of 5 to 24 carbon atom fatty acids. In a preferred aspect, the fatty acids preferably have a carbon chain length of at least 12.

In some embodiments, a C5 to C24 branched or straight chain fatty acid or combination of fatty acids is included in the compositions. In some embodiments, the compositions are substantially free of, or free of, fatty acids with a chain length less than C12, or in other aspects less than C8, or in still other aspects less than C5. For example, in some embodiments, the compositions are free of, or substantially free of, C5 to C11 fatty acids.

Exemplary fatty acids can be selected from hexanoic acid, heptanoic acid, octanoic acid, nonanoic acid, decanoic acid, lauric acid, palmitic acid, stearic acid, oleic acid, caproic acid, caprylic acid, capric acid and mixtures thereof. Exemplary longer alkyl chain fatty acids can be selected from for example myristic acid, arachidic acid, behenic acid, lignoceric acid, cerotic acid, myristoleic acid, palmitoleic acid, sapienic acid, elaidic acid, vaccenic acid, linoleic acid, linoelaidic acid, a-linolenic acid, arachidonic acid, eicosapentaenoic acid, erucic acid, decosahexaenoic acid, gadoleic acid, erucic acid, margaric acid, behenic acid, ricinoleic acid, lignoceric acid, licanic acid, eleostearic acid and mixtures thereof. In some embodiments, two or more fatty acids can be used. In a preferred aspect a mixture of at least lauric acid, stearic acid and/or palmitic acid are employed in the form of soluble alkali metal soaps.

In an aspect of the invention, fatty acids do not include any esters of fatty acids. In an aspect of the invention, esters of fatty acids are unreactive toward calcium ions of the tea and coffee stains. Instead, in order to employ an ester of a fatty acid according to embodiments of the invention, a glyceride or alkyl ester must first be saponified to employ for use in the fatty acid soaps.

The salt of the fatty acid (soap) is preferably a sodium or potassium salt. In aspects of the invention, the salt of the fatty acid (soap) is an amine, such as monoethanolamine, morpholine, alkyl amines, or the like. In still other aspects of the invention, ammonia can also be used. The fatty acid soap according to the compositions is a soluble soap. In some aspects, the fatty acid is combined initially with a neutralizing agent, such as an alkalinity source, preferably an alkali metal hydroxide, to neutralize the acid. As referred to herein, neutralizing agents can include any alkalinity sources disclosed for use in formulating the fatty acid soap composition.

In some embodiments, the fatty acid is present in the compositions at an amount of about 0.01 wt-% to about 100 wt-%, about 0.01 et-% to about 90 wt-%, about 1 wt-% to about 80 wt-%, or about 5 to about 50 wt-%. For example, in some embodiments the alkaline pre-soak composition may employ substantially only the fatty acid soap (and alkalinity source), such that a large amount of the composition is made of the fatty acid soap, without the use of additional functional ingredients. It is to be understood that all ranges and values between these ranges and values are encompassed by the present compositions.

Without wishing to be bound by any particular theory and/or limiting any aspects of the methods of use according to the invention, it has been found that the fatty acid soaps beneficially solubilize the calcium ions associated with the tea and coffee stains (e.g. tannins of the stain, including any polyphenol stain) enabling the removal of the stain. For example, in a non-limiting embodiment of the invention, a sodium stearate soap combined with a polyphenol stain allows the fatty acid to interact with the surface of the stain, wherein the calcium ion on the stain is replaced with the sodium ions from the alkaline pre-soak solution to enable the polyphenol stain to solubilize on the alkaline wash solution and be removed from the surface of the article. In this aspect of the invention, the calcium ion is replaced with an alkali metal or amine in order to solubilize the stain to remove it from the surface of the article or ware.

Alkalinity Source

In some aspects the alkaline pre-soak compositions include an alkalinity source. The alkalinity source is preferably a caustic-based alkalinity source, including, for example, alkali metal hydroxides. Exemplary alkali metal hydroxides that can be used include, but are not limited to sodium, or potassium hydroxide. In preferred aspects, the alkalinity source is sodium hydroxide.

In other aspects, the alkalinity source may be (or may be combined with) carbonate-based alkalinity sources, including, for example, carbonate salts such as alkali metal carbonates; alkali metal silicates, and organic alkalinity sources. Organic alkalinity sources include for example strong nitrogen bases including ammonia, amines, and alkanolamines.

Typical examples of amines suitable for use in the fatty acid soaps according to the invention include primary, secondary or tertiary amines and diamines carrying at least one nitrogen linked hydrocarbon group, which represents a saturated or unsaturated linear or branched alkyl group having at least 1 carbon atom and preferably 1-10 carbon atoms, or an aryl, aralkyl, or alkaryl group containing up to 24 carbon atoms, and wherein the optional other nitrogen linked groups are formed by optionally substituted alkyl groups, aryl group or aralkyl groups or polyalkoxy groups.

Typical examples of alkanolamines suitable for use in the fatty acid soaps according to the invention include, for example, monoethanolamine, monoisopropanolamine, diethanolamine, diisopropanolamine, triethanolamine, triisopropanolamine and the like. In a preferred aspect, an alkanolamine is combined with the fatty acid, preferably monoethanolamine. Beneficially, in an aspect of the invention, alkanolamines do not have undesirable odor which can be associated with other organic alkalinity sources, such as ammonia.

Typical examples of alkanolamines suitable for use in the fatty acid soaps according to the invention include 2-amino-2-methyl-l-propanol, 2-amino-l-butanol, 2-amino-2-methyl-1,3-propanediol, 2-amino-2-ethyl-1,3-propanediol, hydroxymethyl aminomethane, and the like. In preferred aspects, the detergent compositions do not include organic alkalinity sources, as alkali metal hydroxides are preferred.

A number of commercially available alkalinity sources may be suitable for use in embodiments of the present invention. For example, suitable commercially available caustic soda include, but are not limited to, liquid caustic soda (sodium hydroxide) as 50% (alkali equivalent, wt % Na₂O about 39%) and 73% (alkali equivalent, wt % Na₂O about 57%) solutions in water available from PPG Industries. (Pittsburgh, Pa.). Suitable commercially available alkyl alkanolamines include, but are not limited to, monoethanolamine (HOCH₂CH₂NH₂) as MEA grade, MEA LFG grade (an 85% solution of monoethanolamine with 15% water), and MEA ICF grade available from Dow Chemical Company (Midland, Mich.).

In some embodiments, the alkalinity source is present in the fatty acid soap compositions at an amount of about 0.01 wt-% to about 50 wt-%, about 0.1 wt-% to about 50 wt-%, or about 2 to about 40 wt-%. In some aspects, the alkalinity source in the fatty acid soap composition provides at least 100 ppm alkalinity to about 10,000 ppm or greater alkalinity. For example, in some embodiments the alkaline pre-soak composition may employ substantially only the alkalinity source and fatty acid soap, such that a large amount of the composition is made of the fatty acid soap, without the use of additional functional ingredients. It is to be understood that all ranges and values between these ranges and values are encompassed by the present compositions.

The alkalinity source according to the invention provides the fatty acid soap composition solution to have an alkaline pH of at least about 10, and preferably between about 10-11.

Additional Functional Ingredients

Other active ingredients may optionally be used to improve the effectiveness of the pre-soak composition. Minor amount of the additional functional ingredients may be present in the alkaline pre-soak compositions of the invention. Some non-limiting examples of such additional functional ingredients can include: anticorrosion agents, wetting agents, enzymes, enzyme stabilizing agents, soil suspending agents, colorants, fragrances, foam inhibitors, antiredeposition agents, anti-etch agents, antimicrobial agents, anti-foaming agents, solvents, pH modifier, hydrotropes and other ingredients useful in imparting a desired characteristic or functionality in the detergent composition. The following describes some examples of such ingredients.

Additional functional ingredients provide desired properties and functionalities to the compositions of the invention. For the purpose of this application, the term “functional ingredient” includes a material that when dispersed or dissolved in a use and/or concentrate solution, such as an aqueous solution, provides a beneficial property in a particular use. Some particular examples of functional materials are discussed in more detail below, although the particular materials discussed are given by way of example only, and that a broad variety of other functional ingredients may be used. For example, many of the functional materials discussed below relate to materials used in cleaning, specifically ware wash applications. However, other embodiments may include functional ingredients for use in other applications.

Surfactants

The pre-soak compositions according to the invention may optionally contain a surfactant or surfactant mixture. These can be selected from water soluble or water dispersible nonionic, semi-polar nonionic, anionic, cationic, amphoteric, or zwitterionic surface-active agents; or any combination thereof. A typical listing of the classes and species of surfactants useful herein appears, for example, in U.S. Pat. Nos. 3,664,961, 8,071,520, 8,192, 553, 8,222,196, 8,445,419, 8,481,473, 8,617,317. The disclosure of which is hereby incorporated by reference.

In some embodiments, a surfactant component functions primarily as a defoamer and as a wetting agent for solutions according to the invention. Surfactants suitable for use with the compositions of the present invention include, but are not limited to, nonionic surfactants, anionic surfactants, amphoteric surfactants, and zwitterionic surfactants. In some embodiments, the compositions of the present invention include about 0 wt-% to about 50 wt-% of a surfactant. In other embodiments the compositions of the present invention include about 0.1 wt-% to about 30 wt-% of a surfactant. In some embodiments, the compositions of the present invention include about 100 ppm to about 10,000 ppm of a surfactant.

The particular surfactant or surfactant mixture chosen for use in the process and products of this invention can depend on the conditions of final utility, including method of manufacture, physical product form, use pH, use temperature, time required for soaking, and foam control (such as under methods of using the alkaline pre-soak composition within a warewash machine).

In some aspects, the surfactant is preferably a nonionic surfactant and a low HLB nonionic surfactant in particular. HLB (Hydrophilic Lipophilic Balance) refers to a surfactant's solubility in water. An HLB scale was derived as a means for comparing the relative hydrophilicity of amphiphilic molecules. Molecules with an HLB value of 10 or greater indicate that the molecule is hydrophilic and soluble in water. Molecules with an HLB value less than 10 indicate that the molecule is hydrophobic and insoluble in water. The HLB system is well known to skilled surfactant chemists and is explained in the literature such as in the publication, “The HLB System,” ICI Americas (1987). According to an aspect of the invention, preferred nonionic surfactants are alcohol ethoxylate nonionic surfactants. The preferred alcohol ethoxylate nonionic surfactants are those that are capped, for example, halogen or benzyl capped. Some non-limiting examples of commercially available alcohol ethoxylate nonionic surfactants include the following: Dehypon LS 54 available from Henkel; Tomadol 91-6, Tomadol 1-9, Tomadol 1-5, and Tomadol 1-3 available from Tomah; Plurafac D-25, and SLF-18 available from BASF; Sasol C13-9EO, Sasol C8-10-6EO, Sasol TDA C13-6EO, and Sasol C6-10-12EO available from Sasol; Hetoxol 1-20-10 and Hetoxol 1-20-5 available from Laurachem; Huntsman L46-7EO available from Huntman; and Antarox BL 330 and BL 344 available from Rhodia, Pluronic N-3, Plurafac LF-221, Ls-36, Pluronic 25R2, Pluronic 10R5, Novel 1012GB, Pluronic LD-097, Pluronic D-097, Neodol 25-12. Antarox BL 330 and BL 344 are either branched or straight chain C₁₂-C₁₈ halogen capped alcohol ethoxylate nonionic surfactants.

Alkaline Detergent

Suitable alkaline agents include but are not limited to alkali metal hydroxides, e.g. sodium or potassium hydroxide, sodium and potassium carbonates, and alkali metal silicates, e.g. sodium metasilicate may be employed for use as alkaline detergents to be optionally combined with the pre-soak compositions. The level of alkaline agent present in the first component is preferably such that the pH of the use concentration thereof (i.e. the pH applied in the wash zone or step into which the first component is introduced) is in the range of from 8 to 14, more preferably from 10.5-13.

The cleaning agent content of the alkaline detergent typically includes one or more agents selected from builders (i.e. detergency builders including the class of chelating agents/sequestering agents), bleaches, enzymes and surfactants. However, beneficially according to the invention, the use of the pre-soak fatty acid soap compositions obviates the need for use of chelants and/or bleaches. As a result, the following types of builder materials typically found in detergent compositions are not required according to the present invention: including both phosphate and non-phosphate builder materials. Examples of non-phosphate builder materials which are not required for tea and coffee stain removal according to the invention due to the use of fatty acid soap compositions include, for example, alkali metal citrates, carbonates and bicarbonates; and the salts of nitrilotriacetic acid (NTA); methylglycine diacetic acid (MGDA); serine diacetic acid (SDA); imino disuccinic acid (IDS); dipicolinic acid (DPA); oxydisuccinic acid (ODS); alkyl and alkenyl succinates (AKS); ethylenediamine tetraacetates, oxidized heteropolymeric polysaccharides, polycarboxylates such as polymaleates, polyacetates, polyhydroxyacrylates, polyacrylate/polymaleate and polyacrylate/polymethacrylate copolymers and the terpolymer of polyacrylate/polymaleate and vinylacetate (ex Huls), as well as zeolites; layered silicas and mixtures thereof.

Defoaming Agents

In addition to the use of certain nonionic and/or anionic surfactants, the compositions according to the invention may further include a defoaming agent. Suitable defoamers include mono- and distearyl acid phosphates, silicone oils, mineral oils, and organic carriers containing long-chain ketones (e.g. the Dehypon series, ex Henkel KGaA, Germany). In some aspects of the invention, namely use of the alkaline fatty acid soap cleaning compositions within a warewash machine will preferably employ a defoaming agent and/or defoaming surfactant to reduce foam generated in the ware wash machine with use of the fatty acid soap solutions.

Enzymatic Material

An enzyme or combination of enzymes could be used in compositions according to the invention for enhanced soil removal. In an aspect, amylolytic and/or proteolytic enzymes would normally be used.

Amylolytic enzymes usable herein can be those derived from bacteria or fungi. Preferred amylolytic enzymes are those prepared and described in GB Patent No. 1,296,839 cultivated from the strains of Bacillus licheniformis NCIB 8061, NCIB 8059, ATCC 6334, ATCC 6598, ATCC 11945, ATCC 8480 and ATCC 9945 A. An example of such amylolytic enzymes is the amylase produced and distributed under the tradename Termamyl by Novo Industri A/S, Copenhagen Denmark. Other suitable types of amylases because of their oxidation stability are Duramyl (ex Novo) and Purafect OxAm (ex Genencor). These amylolytic enzymes are generally presented as granules or liquids. They may be present in the first component of the system of the invention in amounts such that the final use composition of said component has amylolytic enzyme activity of from 10 to 108 Matose. The amylolytic activity as referred to herein can be determined by the method as described by P. Bernfeld in “Method of Enzymology”, Volume I (1955), page 149.

The proteolytic enzymes usable herein, for instance, the subtilisins which are obtained from particular strains of B. subtilis and B. Licheniformis, such as the commercially available subtilisins maxatase, supplied by Gist-Brocades N. V., Delft, Holland, and Alcalase, supplied by Novo Industri A/S, Copenhagen, Denmark. Particularly suitable are proteases obtained from a strain of bacillus having maximum activity through the pH range of 8-12, being commercially available from NOVO Industri A/S under the tradenames of Esperase and Savinase. The preparation of these and analogous enzymes is described in GB Patent No. 1,243,784. These enzymes are generally presented as granules, e.g. marumes, prills, T-granulates, etc., or liquids and may have enzyme activity of from 500 to 6,000 Glycine Units/mg. The proteolytic enzyme activity can be determined by the method as described by M.L. Anson in “Journal of General Physiology”, Vol. 22 (1938), page 79 (one Anson unit/gram=733 Glycine Units/milligram). In the compositions of the invention, proteolytic enzymes may be present in amounts such that the final use composition of the first component has proteolytic enzyme activity of from about 10 to 1010 Glycine Units/kilogram, preferably from 102 to 1010 and more preferably from 104 to 109.

Additional description of non-lipolytic enzyme compositions suitable for use according to the invention is disclosed for example in U.S. Pat. Nos. 7,670,549, 7,723,281, 7,670,549, 7,553,806, 7,491,362, 6,638,902, 6,624,132, and 6,197,739 and U.S. Patent Publication Nos. 2012/0046211 and 2004/0072714, each of which are herein incorporated by reference in its entirety. In addition, the reference “Industrial Enzymes”, Scott, D., in Kirk-Othmer Encyclopedia of Chemical Technology, 3rd Edition, (editors Grayson, M. and EcKroth, D.) Vol. 9, pp. 173-224, John Wiley & Sons, New York, 1980 is incorporated herein in its entirety.

Water

The compositions may further include water in the compositions and/or use solutions. Those of skill in the art will be capable of selecting the grade of water desired with the desired level of water hardness.

Methods of Using Pre-Soak/Pre-Rinse Compositions

Methods of use according to the invention generally relate to a method of cleaning ware, particularly, cups, saucers, dishes etc. that have been stained with coffee or tea, in a dishwashing machine. According to aspects of the invention, an alkaline pre-soak or pre-wash step is employed. Without being limited according to aspects of the invention, the alkaline cleaning composition of the invention is employed before a wash cycle of a dishwashing application, either outside of the dish machine (e.g. pre-soak) or inside of the dish machine (e.g. pre-wash).

In one embodiment, the methods involve providing an alkaline pre-soak and/or pre-wash composition comprising fatty acid soap. In some aspects, in a traditional ware wash machine, the alkaline fatty acid soap pre-soak may be inserted into a dispenser in a dishwashing machine, forming a solution with the pre-soak composition and water, contacting the stain on an article in the dishwashing machine with the wash solution, and thereafter rinsing the article (and optionally employing further washing and rinsing cycles). Alternatively, the alkaline pre-soak and/or pre-wash may also be performed wholly outside of the warewash machine and followed by a traditional wash cycle with alkaline detergent. In still further aspects of the methods of the invention, using a multi tank ware washing equipment it is also possible to apply the alkaline pre-soak on the first step followed by the alkaline wash. Also, by using a programmable single tank equipment, it is possible to apply the alkaline pre-soak step inside the machine as a separate cycle.

Generally, the methods of the present invention involve first providing an alkaline pre-soak composition comprising a fatty acid soap, forming a wash (or soak) solution with the alkaline composition and water, contacting a soil on an article with the wash solution, and if desired, rinsing the article, and then washing with a traditional alkaline detergent.

In another embodiment, the methods of the present invention involve providing both the alkaline pre-soak composition and a traditional alkaline detergent together in a cleaning application. In this embodiment, a user would clean articles for a period of time using the alkaline pre-soak, and thereafter, the user would switch to the alkaline detergent cleaning compositions.

When carrying out the methods of the invention, the alkaline pre-soak compositions may be provided in a tank or reservoir for the soaking of dishes outside of a ware wash machine. Compositions according to the invention can be dosed into such tank or reservoir in a concentrate and/or ready-to-use solid and/or solution.

Alternatively, the alkaline pre-soak compositions may be dispensed onto dishes in need of tea and/or coffee stain removal. The dispenser may be selected from a variety of different dispensers depending of the physical form of the composition. For example, a liquid composition may be dispensed using a pump, either peristaltic or bellows for example, syringe/plunger injection, gravity feed, siphon feed, aspirators, unit dose, for example using a water soluble packet such as polyvinyl alcohol, or a foil pouch, evacuation from a pressurized chamber, or diffusion through a membrane or permeable surface. If the composition is a gel or a thick liquid, it may be dispensed using a pump such as a peristaltic or bellows pump, syringe/plunger injection, caulk gun, unit dose, for example using a water soluble packet such as polyvinyl alcohol or a foil pouch, evacuation from a pressurized chamber, or diffusion through a membrane or permeable surface. Finally, if the composition is a solid or powder, the composition may be dispensed using a spray, flood, auger, shaker, tablet-type dispenser, unit dose using a water soluble packet such as polyvinyl alcohol or foil pouch, or diffusion through a membrane or permeable surface. The dispenser may also be a dual dispenser in which one component, such as the alkaline component (e.g. fatty acid soap), is dispensed on one side and another component, such as an optional surfactant or antimicrobial agent, and is dispensed on another side. These exemplary dispensers may be located in or associated with a variety of dish machines including under the counter dish machines, bar washers, door machines, conveyor machines, or flight machines. The dispenser may be located inside the dish machine, remote, or mounted outside of the dishwasher. A single dispenser may feed one or more dish machines.

Once the alkaline pre-soak composition is dispensed or added into a tank or reservoir, generally water is added to generate a pre-soak use solution according to the various embodiments of use according to the invention. The wash/pre-soak solution comprises the alkaline pre-soak composition and water. The water may be any type of water including hard water, soft water, clean water, or dirty water. In preferred aspects of the methods of the invention, the water is preferable warm, such as a temperature of at least 100° F., preferably at least 120° F., however in some aspects of the invention the water can be used also at room temperature. The most preferred wash solution is one that maintains the preferred alkaline pH ranges of greater than 7, at least about 8, at least about 9, at least about 10, or more preferably a pH range of at least about 10.5 without an upper pH limit.

After the pre-soak/wash solution is formed, the wash solution contacts the stain on an article to be cleaned. Examples of stains include coffee, tea or other tannin-associated stains and beverages made with them. Articles that may be contacted include articles made of glass, plastic, aluminum, steel, copper, brass, silver, rubber, wood, ceramic, porcelain and the like. Articles include things typically found in a dish machine such as glasses, bowls, plates, cups, saucers, pots and pans, bakeware such as cookie sheets, cake pans, muffin pans etc., silverware such as forks, spoons, knives, cooking utensils such as wooden spoons, spatulas, rubber scrapers, utility knives, tongs, grilling utensils, serving utensils, etc. The pre-soak or pre-wash solution according to the invention may contact the soil in a number of ways including spraying, dipping, sump-pump solution, misting and fogging. In a preferred embodiment, the alkaline composition is in contact with the ware or other soiled substrate by dipping the ware or soiled substrate into a tank or reservoir outside of a ware wash machine.

Once contacted (e.g. submerged in the pre-soak) for a sufficient period of time, the stains are loosened and/or removed from the article. In some aspects the wares need to be “soaked” for a period of time for the alkaline pre-soak to penetrate the stains. In some aspects, the contacting step such as submerging the ware or substrate in need of stain removal further includes the use of warm water to form the pre-soak solution in contact with the stains for at least a few seconds, preferably at least about 45 seconds to 24 hours, preferably at least about 45 seconds to 6 hours, preferably at least about 60 seconds to 1 hour, and more preferably for at least about 60 seconds to 10 minutes. In some aspects, wherein the pre-soak is applied within a warewash machine, the soaking period of time may be from about 10 seconds to 20 minutes in an institutional machine, and optionally longer in a consumer machine. In a preferred aspect, the pre-soak is applied (e.g. ware is soaked in the alkaline fatty acid soap solution) for a period of at least 60 seconds, preferably at least 90 seconds. Beneficially, the soaking of ware or stained articles according to the invention does not require agitation; however, use of agitation may be employed for further removal of soils. In an aspect of the invention, the length of time the ware or stained articles are soaked in the use solution of the fatty acid soap improves the removal of soils during a subsequent wash cycle using an alkaline detergent.

In some aspects, the concentration of fatty acid soap in a use solution for contacting ware or stained articles is at least about 100 ppm to 10,000 ppm, which is inclusive of all ranges of the concentration. In an aspect, the longer the exposure to the fatty acid soap solution and/or the increase in amount of time and/or concentration of the fatty acid soap solution beneficially reduces the amount of time needed to remove the remaining stain in a conventional warewashing cycle and/or a manual stain removal.

In some aspects, the final removal of the soil from the article may be accomplished by an alkaline wash cycle or step in a conventional, domestic and/or institutional warewashing machine. However, as mentioned above, both the alkaline cleaning composition comprising the fatty acid soap and a warewashing detergent can both be used in a warewashing machine. For example, typical institutional warewashing processes are either continuous or non-continuous and are conducted in either a single-tank or a multi-tank/conveyor-type machine. Domestic warewashing processes and machines can further be employed.

As one skilled in the art will ascertain a conventional warewash application can thereafter, once the soil is removed, further include the rinsing of the articles.

The method can include more steps or fewer steps than laid out here. For example, the method can include additional steps normally associated with a dish machine wash cycle including a wash with a traditional alkaline detergent to remove other soils. In accordance with a preferred embodiment of the invention, a conventional alkaline detergent composition is employed in a wash cycle after use of the pre-soak and/or pre-wash. In some aspects, the alkaline detergent composition has preferably a pH above about 10, or preferably at least about 12.

In accordance with a preferred embodiment of the invention, the application of the alkaline detergent composition follows that of the alkaline pre-soak composition. In addition, as one may also appreciate, additional steps of detergent application and rinsing may be added to the above washing sequence, such as for example alternative washing and rinsing cycles, including either alkaline and/or acid detergent compositions and rinse compositions.

### EXAMPLES

Embodiments of the present invention are further defined in the following non-limiting Examples. It should be understood that these Examples, while indicating certain embodiments of the invention, are given by way of illustration only. From the above discussion and these Examples, one skilled in the art can ascertain the essential characteristics of this invention, and without departing from the spirit and scope thereof, can make various changes and modifications of the embodiments of the invention to adapt it to various usages and conditions. Thus, various modifications of the embodiments of the invention, in addition to those shown and described herein, will be apparent to those skilled in the art from the foregoing description. Such modifications are also intended to fall within the scope of the appended claims.

### Example 1

Methods for assessing tea-stained tile cleaning performance were performed. Initially, tiles were washed in standard dishmachine with a highly alkaline detergent containing a high concentration of chelants such as Guardian Plus supply by ECOLAB. Cycles on the dish machine are run until the tiles are fully clean. Tiles are then ready to be soiled.

To prepare tiles for testing, a tea bath was filled with 17 grain hard water and heated to 180° F. using a steam line. 150 Lipton black tea bags were added and agitated for about 5 minutes. The tea bags were removed while squeezing the liquid out of them into the broth. The temperature in the bath was then decreased to about 155-160° F. Then the airline leading to the tea bath was turned on. A set of tiles was added to a rack in a dipper so that the tiles were dipped 25 times for a period of 1 minute each time in the solution and 1 minute out of solution for each dip. If necessary, deionized water was added to the dipper to replace any water loss by evaporation. The tiles were then allowed to air dry for 3 days (or baked in an oven at 180° F. for 2 hours before testing).

To determine the ability of compositions of the present invention to remove soil, stained tiles were submerged into beakers of various cleaning compositions. Before the tiles were washed, the amount of soil on the tiles was noted by taking pre-cleaned pictures and visual assessments of the tiles. Beakers of test solutions were prepared as shown in Table 2, wherein the concentration of additive in solution with the water source was made in separate beakers. The solutions were stirred at 100 rpm. The tea stained tiles were dipped into the respective beaker for 45 seconds and up to 3 minutes. After the dip the same tile was dipped into a beaker (containing sodium hydroxide at 450 ppm) for 45 seconds or as low as 10 seconds. Thereafter the tile was visually analyzed to assess the cleanliness of the tile. The last three tests shown in Table 2 shows the effect of the dipping time on the soap solution to the dipping time on the caustic solution to get total removal of the tea stain. The results are set forth in Table 2.

TABLE 2

| | | Con- | | | | | |
|---|---|---|---|---|---|---|---|
| | | centra- | | | Time | Time | |
| | | tion | | T | Soap | NaOH | |
| Tile # | Soap | ppm | pH | ° F. | (sec.) | (sec.) | Results |
| None | Potassium | 10,000 | 11 | 90 | 90″ | 45″ | Total |
| | Cocoate | | | | | | remotion |
| | | | | | | | (i.e. |
| | | | | | | | removal |
| | | | | | | | of soil) |
| 1 | Potassium | 5,000 | 11 | 80 | 60″ | 45″ | Total |
| | Cocoate | | | | | | remotion |
| 2 | Potassium | 5,000 | 11 | 80 | 90″ | 45″ | Total |
| | Cocoate | | | | | | remotion |
| 3 | Sodium | ~1,000 | 11 | 80 | 60″ | 45″ | Partial |
| | Stearate | | | | | | remotion |
| 4 | Sodium | ~1,000 | 11 | 80 | 90″ | 45″ | Total |
| | Stearate | | | | | | remotion |
| 5 | Sodium | 5,000 | 10 | 80 | 60″ | 45″ | Total |
| | Oleate | | | | | | remotion |
| 6 | Sodium | 5,000 | 10 | 80 | 90″ | 45″ | Total |
| | Oleate | | | | | | remotion |
| 7 | Sodium | 5,000 | 10 | 80 | 60″ | 45″ | Total |
| | Oleate | | | | | | remotion |
| 10 | Potassium | 100 | 10 | 80 | 120″ | 45″ | Partial |
| | Cocoate | | | | | | remotion |
| 11 | Potassium | 500 | 10 | 80 | 90″ | 45″ | >85% |
| | Cocoate | | | | | | Removed |
| 12 | Potassium | 1,000 | 10 | 80 | 90″ | 45″ | >98% |
| | Cocoate | | | | | | Removed |
| 13 | Potassium | 1,000 | 10 | 80 | 120″ | 45″ | >85% |
| | Cocoate | | | | | | Removed |
| 14 | Potassium | 1,000 | 10 | 80 | 180″ | 45″ | Total |
| | Cocoate | | | | | | remotion |
| 15 | Potassium | 5,000 | 10 | 80 | 45″ | 45″ | Total |
| | Cocoate | | | | | | remotion |
| 16 | Potassium | 5,000 | 10 | 80 | 60″ | 30″ | Total |
| | Cocoate | | | | | | remotion |
| 17 | Potassium | 5,000 | 10 | 80 | 75″ | 25″ | Total |
| | Cocoate | | | | | | remotion |
| 18 | Potassium | 5,000 | 10 | 80 | 120″ | 10″ | Total |
| | Cocoate | | | | | | remotion |

As shown in Table 2, the soaps containing fatty acid salts in various water conditions for a short period of time yielded some removal of the tea stains. Further testing was employed to demonstrate efficacy of the fatty acid soap to modify the solubility of the stains for subsequent complete removal in a warewashing application. The variation in tested temperatures of the beaker water demonstrate the applicability of applications of use varying from seconds to minutes when employed as a pre-treatment soak for substrates in need of cleaning or removal of the tea and coffee stains. In general, the testing confirms that the use of a room temperature pre-treatment soak for longer contact time decreases the time needed by the caustic solution to remove the tea stain. In addition, cleaning performance using non-DI water was preferred as most commercial applications of the compositions according to the invention will not have DI water available. Therefore the results are applicable to any water hardness according to the invention.

### Example 2

Additional evaluation of the alkaline fatty acid soap made of oleic acid and 50% sodium hydroxide was conducted. Table 3 shows the test results of the soap solution with concentrations of 10,000 ppm tested at room temperature for 1 minute and 30 seconds without agitation.

TABLE 3

| TRIAL | PPM (sodium oleate) | RESULT |
|---|---|---|
| 1 | 10000 | Completely clean |
| 2 | 10000 | Completely clean |
| 3 | 10000 | Completely clean |

### Example 3

Additional assessments of tea-stained tile cleaning performance were performed using an ethanolamine salt of the fatty acid. Tiles were prepared using the same methods of Example 1. Soap solutions were prepared using oleic acid (81.9 grams) and monoethanolamine (99%, 18.1 grams) and stirred until a gel formed. 10% extra monoethanolamine was added to increase the pH. Sufficient soap solution is added to 1 L of deionized water to make the desired concentrations of soap solution, and enough monoethanolamine to get a pH of 10 at the dilute form.

The soap solution concentrations tested are shown in Table 4, and it was maintained at approximately 80° F. The tiles were then placed in a 450 ppm caustic solution for 45 or 10 seconds.

TABLE 4

| | | | | | Ag- | | |
|---|---|---|---|---|---|---|---|
| Tile | | Concen- | | | ita- | NaOH | |
| # | Soap | tration | pH | Time | tion? | Time | Results |
| 101 | MEA | 1000 ppm | 10 | 60 sec | No | 45 sec | Partial |
| | Oleate | | | | | | removal |
| 102 | MEA | 1000 ppm | 10 | 60 sec | Yes | 10 sec | Total |
| | Oleate | | | | | | removal |
| 103 | MEA | 1000 ppm | 10 | 30 sec | Yes | 45 sec | 90% |
| | Oleate | | | | | | Removal |
| 104 | MEA | 500 ppm | 10 | 60 sec | No | 45 sec | >50% |
| | Oleate | | | | | | Removal |
| 105 | MEA | 500 ppm | 10 | 60 sec | Yes | 45 sec | Total |
| | Oleate | | | | | | removal |
| 106 | MEA | 500 ppm | 10 | 60 sec | Yes | 45 sec | >95% |
| | Oleate | | | | | | Removal. |
| | | | | | | | Tile was |
| | | | | | | | heavily |
| | | | | | | | stained |
| 107 | MEA | 500 ppm | 10 | 30 sec | Yes | 45 sec | 90% |
| | Oleate | | | | | | Removal |

If agitation is applied during the soaking period, the tea stain removal by the caustic solution is further facilitated (see tile 101 VS 102). The data illustrate that ethanolamines are further suitable for use according to compositions of the invention, with enhanced benefits over the corresponding sodium or potassium salts. At 500 ppm, the MEA Oleate with a soaking time of 60 seconds and agitation, facilitated the total removal of the tea stain by the hot caustic solution on 45 seconds in contrast to the potassium cocoate at 500 ppm and 1.5 minutes soaking time with just 85% removal.

The results show a benefit of using monoethanolamine as the counter ion for the fatty acid soap cleaning compositions

### Example 4

Additional testing cycling between caustic solution to the alkaline fatty acid soap solution back to caustic was conducted using the sodium oleate solution at 10,000 ppm and a formulated caustic detergent containing polymers and sodium hydroxide (450 ppm), dissolved into deionized water. Table 5 shows the results of the evaluation.

TABLE 5

| | CONCENTRATION | |
|---|---|---|
| TRIAL | (ppm) | RESULT |
| 1 | 10000 | Completely clean |
| 2 | 10000 | Completely clean |
| 3 | 10000 | Completely clean |
| 4 | 10000 | Completely clean |

Beneficially according to an aspect of the invention, the cycling process aid in stain removal according to aspects of the invention.

### Example 5

Tile cleaning was also analyzed in warewashing machines. As prior testing showing use of the fatty acid alkaline pre-soak compositions in combination with caustic solutions (and also caustic solutions with polymers) provide tea stain soil removal, additional testing was conducted in warewashing machines. Stained tiles (in this case stained times from experiments having set in for over 2 months as described in Example 1) were soaked in an alkaline solution of 10,000 ppm sodium stearate solution at room temperature for 1 minute or 2 minutes. A warewash machine was dosed with 450 ppm caustic and the soaked tiles were run through one round of a warewash cleaning cycle. The caustic was added to a 60 L tank (54 grams of 50% NaOH). The tiles were then observed and cleaning results recorded. The results are shown in Table 6.

TABLE 6

| | | SOAK | |
|---|---|---|---|
| TRIAL | CONCENTRATION | TIME (min) | RESULT |
| 1 | 1% | 1 | Some cleaning |
| 2 | 1% | 1 | ⅔ tiles completely |
| | | | clean; third tile no |
| | | | significant cleaning |
| 3 | 2% | 2 | ⅓ tile completely clean; |
| | | | ⅓ tile had some |
| | | | cleaning; third tile no |
| | | | significant cleaning |
| 4 | 2% | 2 | ⅔ tiles completely |
| | | | clean; third tile was |
| | | | completely cleaned |

The length of time the stains set into the tiles presented a concern over ability to clean the soils with short soak times at room temperature. According to an aspect, the longer the set time of polyphenol polymeric stains (such as coffee and tea stains) as described in this invention, it would be beneficial to allow longer soak times and/or soaking under elevated temperatures. Beneficially some cleaning was shown despite these harsh stain conditions.

To address these prior testing condition new tiles were soiled and then tested according to the same warewash machine methods of this Example after letting the soils set for only 48 hours. Only 1% concentration was tested for the experiment as interim testing using new soils (not set in for 48 hours as used in this experiment) provided complete cleaning at 1%, therefore the 2% concentration was not required. Results are shown in Table 7.

TABLE 7

| | | SOAK | |
|---|---|---|---|
| TRIAL | CONCENTRATION | TIME (min) | RESULT |
| 1 | (control) | — | No cleaning |
| 2 | 1% | 1 | Complete cleaning |
| 3 | 1% | 1 | Complete cleaning |
| 4 | 1% | 1 | Complete cleaning |
| 5 | 1% | 1 | Complete cleaning |

Trials 4-5 were conducted with the tiles facing down to ensure that both positions of the stained tile in the ware wash machine received equal water distribution. As shown in the results all testing provided completely clean results; however a control using only the warewash caustic solution did not provide any soil removal. According to an aspect of the invention, the 1% sodium stearate soap solution providing an initial pre-soak for 1 minute at room temperature combined with the ware being run through a single warewash application in a dishmachine provides completely removal of the harsh soils.

The inventions being thus described, it will be obvious that the same may be varied in many ways. Such variations are not to be regarded as a departure from the spirit and scope of the inventions and all such modifications are intended to be included within the scope of the following claims.

1-11. (canceled)

12. A dishwashing method comprising:
applying a use solution of a fatty acid soap composition to a plurality of soiled ware, wherein said alkaline fatty acid soap composition comprises a branched or straight chain C8 to C24 fatty acid(s) and an alkalinity source, wherein the fatty acid soap composition is present in the use solution at a concentration between about 100 ppm and 20,000 ppm;
applying an alkaline detergent composition to said ware; and
rinsing with water;
wherein said alkaline detergent composition has a pH above about 10 and said fatty acid soap composition has a pH above about 10;
wherein said alkaline fatty acid soap composition is applied either before said ware are placed in a warewash machine or within said warewash machine as a cycle in said warewashing,
wherein said alkaline fatty acid soap composition solubilizes said soils for removal, and
wherein said removal of soils does not include use of an acidic cleaning step, chelants, bleach and/or bleach activators.

13. The method of claim 12, wherein said fatty acid soap composition has a pH of at least about 10.5.

14. The method of claim 12, wherein said fatty acid soap composition further comprises a neutralizing agent for said fatty acid, and wherein said alkalinity source is selected from the group consisting of an alkali metal hydroxide, an alkali metal carbonate, an amine, an alkanolamine, an alkylamine or mixtures thereof.

15. The method of claim 12, wherein said soils are from tea, coffee and/or other polyphenol stains, and wherein said application of said fatty acid soap composition is a spray, pre-soak or immersion of said ware in said composition outside of said warewash machine allowing said ware to soak for at least about 10 seconds.

16. The method of claim 12, further comprising a rising step including the use of a rinse aid.

17. The method of claim 12, wherein said fatty acid soap composition comprises from about 0.01-90 wt-% fatty acid and from about 2-40 wt-% alkalinity source, and wherein said compositions provides between about 100 ppm and 10,000 ppm fatty acid soap in use solution.

18. An alkaline fatty acid soap cleaning composition comprising:
a branched or straight chain C8 to C24 fatty acid(s);
a neutralizing agent for said fatty acid; and
an alkalinity source,
wherein said cleaning composition has a use pH of at least about 10.

19. The composition of claim 18, wherein said alkalinity source is an alkali metal hydroxide, an alkali metal carbonate, an amine, an alkanolamine, an alkylamine or mixtures thereof.

20. The composition of claim 18, wherein said fatty acid is selected from the group consisting of hexanoic acid, heptanoic acid, octanoic acid, nonanoic acid, decanoic acid, lauric acid, palmitic acid, stearic acid, oleic acid, myristic acid, arachidic acid, behenic acid, lignoceric acid, cerotic acid, myristoleic acid, palmitoleic acid, sapienic acid, elaidic acid, vaccenic acid, linoleic acid, linoelaidic acid, a-linolenic acid, arachidonic acid, eicosapentaenoic acid, erucic acid, decosahexaenoic acid, caproic acid, caprylic acid, capric acid, gadoleic acid, erucic acid, margaric acid, behenic acid, ricinoleic acid, lignoceric acid, licanic acid, eleostearic acid and mixtures thereof.

21. A dishwashing method comprising:
applying a fatty acid soap composition in a use solution to a plurality of soiled ware, wherein said alkaline fatty acid soap composition comprises from about 0.01-90 wt-% of a branched or straight chain C8 to C24 fatty acid(s) with an amine or ammonia salt, and from about 0.01-50 wt-% of an alkalinity source, wherein the fatty acid soap composition is present in the use solution at a concentration between about 100 ppm and 20,000 ppm;
applying an alkaline detergent composition to said ware; and
rinsing with water;
wherein said alkaline detergent composition has a pH above about 10 and said fatty acid soap composition has a pH above about 10;
wherein said alkaline fatty acid soap composition is applied either before said ware are placed in a warewash machine or within said warewash machine as a cycle in said warewashing,
wherein said alkaline fatty acid soap composition solubilizes said soils for removal, and
wherein said removal of soils does not include use of an acidic cleaning step, chelants, bleach and/or bleach activators.

22. The method of claim 21, wherein said fatty acid soap composition has a pH of at least about 10.5.

23. The method of claim 21, wherein said fatty acid soap composition further comprises a neutralizing agent for said fatty acid, and wherein said alkalinity source is selected from the group consisting of an alkali metal hydroxide, an alkali metal carbonate, an amine, an alkanolamine, an alkylamine or mixtures thereof.

24. The method of claim 21, wherein said soils are from tea, coffee and/or other polyphenol stains, and wherein said application of said fatty acid soap composition is a spray, pre-soak or immersion of said ware in said composition outside of said warewash machine allowing said ware to soak for at least about 10 seconds.

25. The method of claim 21, further comprising a rising step including the use of a rinse aid.

26. The method of claim 21, wherein said fatty acid soap composition comprises from about 5-80 wt-% fatty acid and from about 2-40 wt-% alkalinity source, and wherein said compositions provides between about 100 ppm and 10,000 ppm fatty acid soap in use solution.

27. The method of claim 21, wherein said fatty acid soap is selected from the group consisting of stearate, cocoate, oleate, and mixtures thereof.
